(19) United States
(12) Patent Application Publication
(10) Pub. No.: US 2025/0288898 A1
(43) Pub. Date: Sep. 18, 2025

(54) RFID BLACKJACK

(71) Applicant: Silvan Warnick, South Jordan, UT (US)

(72) Inventor: Silvan Warnick, South Jordan, UT (US)

(21) Appl. No.: 18/608,433

(22) Filed: Mar. 18, 2024

(51) Int. Cl. A63F 1/18; A63F 1/00; A63F 1/02; A63F 1/14; G06K 7/10

(52) U.S. Cl. CPC A63F 1/18; A63F 1/02; A63F 1/14; G06K 7/10316; A63F 2001/003

(57) ABSTRACT

A playing card reading device includes an antenna, and a Radio Frequency Identification (RFID) reader connected to the antenna. The RFID reader is configured to transmit and receive one or more signals to read a value of one or more playing cards. A memory is configured to store the value of the one or more playing cards read by the RFID reader. A processor is connected to the memory, the processor is configured to add or identify the value of each of the one or more playing cards stored in the memory. A transducer is configured to receive a signal from the processor and output one or more of an audio indication, a visual indication, an audio-visual indication, and/or a tactile indication that a predetermined numerical or alphanumerical value of the added or identified one or more playing cards has occurred. The transducer optional receives the signal from the processor after an insurance bet status is input.

### BACKGROUND

### Technical Field

The present disclosure generally relates to card games using Radio Frequency Identification (RFID) cards. More particularly, the present disclosure is generally related to card games including but not limited to blackjack.

### Description of the Related Art

RFID Poker Playing Cards, which are also referred to as NFC poker cards or RFID playing cards, have become increasingly popular in casinos and some tournaments such as the World Poker Tournament®. RFID playing cards may be made of PVC or paper, and the card is embedded with a passive RFID microchip and antenna inside.

### SUMMARY

In one embodiment, a playing card reading device includes an antenna, and a Radio Frequency Identification (RFID) reader connected to the antenna. The RFID reader is configured to transmit and receive one or more signals to read a value of one or more playing cards. A memory is configured to store the value of the one or more playing cards read by the RFID reader. A processor is connected to the memory, the processor is configured to add, combine or identify the value of each of the one or more playing cards stored in the memory. A transducer is configured to receive a signal from the processor and output one or more of an audio indication, a visual indication, an audio-visual indication, and/or a tactile indication that a predetermined numerical value of the added or identified one or more playing cards has occurred.

In an embodiment, the RFID tag of the one or more playing cards has a numerical value or an alphanumerical value received by the RFID reader.

In an embodiment that may be combined with the preceding embodiment, the value of at least one of the playing cards read by the RFID reader is a dealer hole-card in which its value is not visible from a back side of the playing card.

In an embodiment that may be combined with one or more of the preceding embodiments, at least some of the one or more of playing cards is a face card, or a 10 card and the processor assigns a 10 or an alphanumeric value as the value of that card.

In an embodiment that may be combined with one or more of the preceding embodiments, the combined numerical value or combined alphanumerical value of the identified one or more playing cards is equal to the predetermined value identified by the processor or “blackjack”.

In an embodiment that may be combined with one or more of the preceding embodiments, the processor enters a standby mode allowing time for an insurance bet to be placed or declined by each player prior to outputting the signal to activate the transducer.

In an embodiment that may be combined with one or more of the preceding embodiments, an ace card includes a predetermined numeric or alphanumeric value read by the RFID reader.

In an embodiment that may be combined with one or more of the preceding embodiments, the card reading device is a blackjack game device, and the processor is further configured to send an output to activate the transducer in response to the predetermined numerical value or alphanumerical value of the combined or identified playing cards as equaling the combined predetermined value identified by the processor.

In an embodiment that may be combined with one or more of the preceding embodiments, the RFID reader reads an RFID tag of two playing cards of a dealer, the two playing cards include one playing card facing up, and another playing card that is the dealer's hole card facing down.

In an embodiment that may be combined with one or more of the preceding embodiments, each of the one or more playing cards include an RFID tag indicating a numerical value or an alphanumerical value.

In an embodiment that may be combined with one or more of the preceding embodiments, the RFID tag is arranged between a front side and a back side of each of the one or more playing cards.

In an embodiment that may be combined with one or more of the preceding embodiments, the value of the playing cards read by the RFID reader includes at least one of a numerical value or an alphanumerical value.

In one embodiment, a Radio Frequency Identification (RFID) playing card includes a front side displaying a visual identifier, and a back side opposite the front side. An RFID tag is arranged between the front side and the back side of the playing card. The RFID tag is configured with the predetermined value correlating to the identifier displayed on the front side of the playing card, whether it be a numerical or alphanumerical value.

In an embodiment that may be combined with the preceding embodiment, the value configured in the RFID tag is a numerical value or an alphanumerical value.

In an embodiment that may be combined with one or more of the preceding embodiments, the identifier on the front side of the playing card is a royal face, or a 10 card and the numerical value or alpha numerical value configured in the RFID tag is identified by the processor being a predetermined numeric value or alpha numeric value.

In an embodiment that may be combined with one or more of the preceding embodiments, including more than one numerical value or alphanumerical value associated with the identifier.

In an embodiment that may be combined with one or more of the preceding embodiments, when the front of the card identifier is an ace, the card value comprises either a predetermined numerical value or alphanumerical value.

In one embodiment, a computer-implemented method of RFID (Radio Frequency Identification) blackjack, includes scanning, by an RFID reader, two playing cards dealt to a dealer. A numerical value or alphanumerical value of each of the two playing cards dealt to the dealer is transmitted to a processor and/or a memory. The numerical value of each of the two playing cards dealt to the dealer is identified by the processor. A transducer is activated in response to receiving a signal from the processor to output one or more of an audio indication, a visual indication, an audio-visual indication, and/or a tactile indication that the two playing cards dealt to the dealer is equal to the predetermined numerical value or alphanumerical value.

In an embodiment that may be combined with the preceding embodiment, the scanning of the one of the two playing cards dealt to the dealer is a hole-card that faces downward so that its value is not visible from a back side of the playing card.

In an embodiment that may be combined with one or more of the preceding embodiments, the computer-implemented method further includes entering into a standby mode when the exposed dealer's second card dealt, or up card is an Ace.

In an embodiment that may be combined with one or more of the preceding embodiments, the predetermined numerical value or alphanumeric value is established in the processor, and the value of each of the two playing cards shown on a front side matches a value on an RFID tag arranged between the front side and the back side of each of the two playing cards.

In an embodiment that may be combined with one or more of the preceding embodiments, the computer-implemented further includes entering a standby mode to allow time to determine whether an insurance bet has been placed or declined by each player prior to outputting the signal to activate the transducer to output the one or more of the audio indication, the visual indication, the audio-visual indication, and/or the tactile indication.

In an embodiment that may be combined with one or more of the preceding embodiments, the computer-implemented further includes tracking points for one or more players according to house rules of blackjack.

In an embodiment that may be combined with one or more of the preceding embodiments, the computer-implemented further includes storing the tracking points in a storage device for the one or more players based on a membership status.

### BRIEF DESCRIPTION OF THE DRAWINGS

The drawings presented herein show illustrative embodiments of the disclosure. They do not illustrate all embodiments. Other embodiments may be used in addition to or instead of the illustrative embodiments. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps. The drawings are not intended to depict every feature of every implementation nor relative dimensions of the depicted elements, and are not drawn to scale.

FIG. 1 is a block diagram of an RFID card reading system, consistent with an illustrative embodiment.

FIG. 2 illustrates a RFID card, consistent with an illustrative embodiment.

FIG. 3 is an illustration of a table including the RFID card reading system, consistent with an illustrative embodiment.

FIG. 4 is a flowchart providing an operational overview of a computer-implemented method of an RFID blackjack, consistent with an illustrative embodiment.

### DETAILED DESCRIPTION

In the following description, numerous specific details are set forth to clearly describe various specific embodiments disclosed herein. One skilled in the art, however, will understand that the subject matter of the present disclosure may be practiced without all of the specific details discussed below. In other instances, well-known features may not have been described so as not to obscure the invention with unnecessary detail regarding known features.

As used herein, the term “and/or” is to be interpreted broadly is to be understood to refer to all or some of the elements. For example, “at least one of (a) and/or (b) means the teaching pertains only to element (a), or only to element (b), or to both element (a) and element (b). In another example, “at least one of (a), (b), and/or (c), means the teaching pertains to only element (a), or only to element (b), or only element (c), or to elements (a) and (b), elements (a) and (c), elements (b) and (c), or to all of (a), (b) and (c).

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the invention may be implemented in software. As such, it should be noted that a plurality of hardware and software-based devices, as well as a plurality of different structural components may be utilized to implement the subject matter of the present disclosure. Furthermore, and as described in subsequent paragraphs, the specific mechanical configurations illustrated in the drawings are intended to exemplify embodiments of the subject matter of the present disclosure.

As used herein, the term “hole card” refers to a card facing down so that its denomination cannot be seen. When playing blackjack, the dealer's hole card is a downward facing card and its denomination is not initially revealed to the other players.

As used herein, the term “royal card” generally refers to a jack, queen, king or 10 playing card. A “face card” is also known in the art as a jack, queen or king. In blackjack royal cards (e.g., face cards) typically have a value of 10. If alphanumerical values are used, then for example, while an Ace may have an “A”, the royal cards or a 10 may have a “B” or similar alphanumerical designated values. A joker (i.e., a wildcard) is usually not used, but if it is used may have any designated value as set by the game rules.

As used herein, the term “RFID playing cards” generally refers to any set of playing cards (typically 52 cards, however there may be multiple decks combined) used for blackjack or poker, in which these cards have an RFID tag and antenna between a front side and back side of the playing cards. The RFID card are usually without their own power source, but RFID playing cards with batteries may be used. on a gaming table, such as for blackjack or poker, there can be one or a plurality of RFID readers arranged at intervals to read the card values of other players in addition to the dealer. Each player station may have a unique identifier that is read by the RFID reader so that the processor can keep score of all of the players hands.

As used herein, the term “transducer” is to be interpreted broadly and may include a hologram, a monitor, a display, a tablet a smartphone, a laptop, as well as a light, strobe, buzzer, video, etc. In an embodiment, the RFID reader is part of a smartphone, and the processor is a smartphone processor configured with a playing card app, such as an RFID blackjack app.

It is to be understood that the present disclosure provides for a more efficient and accurate way to play blackjack. There may be a savings in power and processing, as well as providing an improvement in the field of games with RFID playing cards.

### Overview

The present disclosure is directed to a device and method of card playing. More particularly, in at least some of the embodiments herein, the device and method are directed to RFID blackjack. however, RFID poker or other games of changes using playing cards are within the purview of the present disclosure. In one embodiment a blackjack table may be covered, for example, with a foam pad and felt. Underneath the foam pad and felt is the card reader that relays the numeric or alphanumeric card value (e.g., 21 or not) to a processor/CPU to at least one of an LED light strip and/or a display, hologram fan, etc. In another embodiment, an RFID system may include only the card reader and a light or display, or just the card reader, and users supply their own RFID cards and a display. The display could be a computer display, an electronic tablet, or a smartphone or other device to receive a signal from the processor. In another embodiment, the card reader may be incorporated into a tablet or a smartphone, which is simply arranged on a stand on its side to read the RFID cards and then indicate whether or not the card value is a designated target value by the processor such as 21 (blackjack).

It is to be understood that although a typical standard for RFID worldwide is 13.56 MHz, the RFID blackjack device and RFID cards are not limited to operation at 13.56 MHz. For example, other frequencies, including but not limited to frequencies from about 3 to about 30 MHz, frequencies from about 30 KHz to about 300 KHz (typically in this range 125 KHz and 134.2 KHz) may be used for RFID. Other frequencies may also be used and it is to be understood that the aforementioned examples of ranges are not in any way exhaustive of the frequencies that may be used for RFID. The RFID card may be constructed of a plastic such as polyvinyl chloride (PVC) or a paper card that is embedded with an antenna and a passive RFID microchip inside.

This RFID card reading device according to the present disclosure eliminates card marks and stripes on the faces of the playing cards. The new method of determining whether the dealer's hand does or does not have blackjack is performed without revealing the dealer's hole card. If the first two cards are dealt the dealer has a combination totaling 21 or the combined predetermined values, that round of play would stop, rendering all other hands subjected to the dealer's hand of blackjack.

A deck of Near Frequency Communication (NFC) cards technology may be used, and/or radio frequency identification (RFID) cards may also be used in an embodiment of the present disclosure. Each playing card may be encoded (tagged) with its own digital code (alphanumeric, digital, or combination codes). An RFID antenna and reader is located wherever necessary, including, but not limited to, the designated spots at the dealer position or players position at the table where the game is being played. The RFID cards are dealt in a standard fashion of play. The first two cards dealt to the dealer, the first face down (hole card) and the second face up, are read by the RFID reader. Each card dealt by the dealer has its unique code, and the assigned value is then added by a computer. If the value of the first two cards dealt the dealer has a predetermined assigned combination value by the processor, play is stopped and a monitor may display blackjack, or a light may display a certain color. There may also be an audio alert and/or an audiovisual alert, as the dealer's hand of 21 wins. In an embodiment, if the value of the first two cards dealt the dealer hand does not meet the predetermined assigned combination value established by the processor, play continues as the dealer's hand has not met the predetermined value.

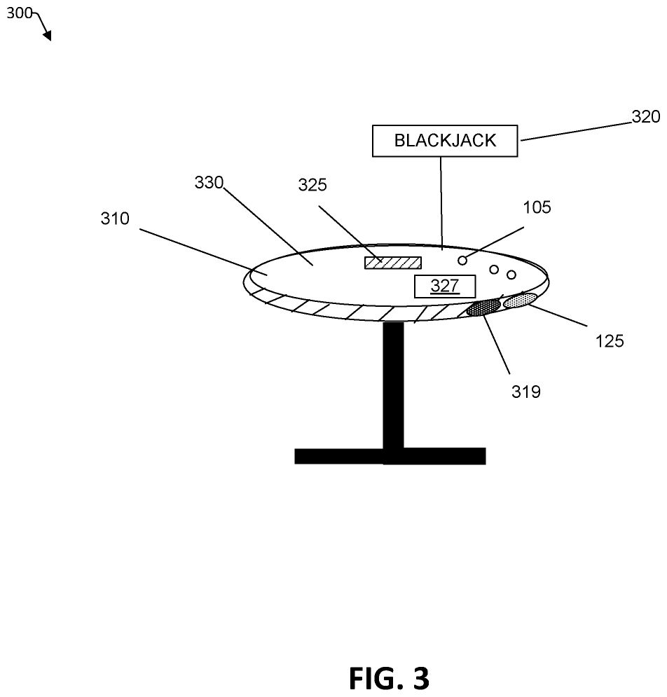

This combination, with the ace card showing, equaling the predetermined value (e.g., twenty-one) is not divulged to the players until all players have had the opportunity to place an insurance bet or decline to place an insurance bet. After insurance bets are offered, there may be a pressure sensor 327 (FIG. 3), or another type of sensor, that engages a monitor display, a visual alert, an audio alert and/or an audiovisual alert. The prompt may be automatic or performed by the dealer. For example, after sensors on the table sense that the dealer has received two cards, the up card being a predetermined value, the processor enters standby mode allowing time for insurance bets. After insurance bets are placed or declined, the dealer activates the pressure sensor 327 (or other type of sensor) which has a mechanism by which a relay will be sent to a device such as a light, monitor, hologram or hologram fan, etc. or otherwise which will indicate whether or not the dealer has Blackjack without revealing the value of the dealer's hole card.

There may be displayed an insurance bet prompt prior to proceeding to read or identify the dealer's cards to determine if the dealer has the predetermined value or blackjack. After the declining or placing the insurance bet the dealer has a mechanism by which a relay will be sent to a device such as a light, monitor, hologram or hologram fan, etc. or otherwise which will indicate whether or not the dealer has Blackjack without revealing the value of the dealer's hole card.

If a monitor or hologram is used, a video image which may be a celebrity such as John Wayne saying, “Dealer has Blackjack pilgrim.” In another embodiment, a known cartoon character may say, “You're going to win this time. Dealer doesn't have Blackjack.” Other examples include but are not in any way limited to a woman on the beach turns, winks and says, “play on, no blackjack. Good luck.” Any other material informing the players that the dealer does or doesn't have a Blackjack. Play would then continue in its normal fashion.

A hard-wired or wireless signal may be transmitted from the card reader to the processor and/or the display using a protocol including, but not in any way limited to one or more of Bluetooth, Bluetooth Low Energy (LE), 802.11(a) to end, WIFI 1 to Wi-Fi_33 7, or near-field communication (NFC). Visual Light Communication (VLC) may also be used.

### Example Embodiment(s)

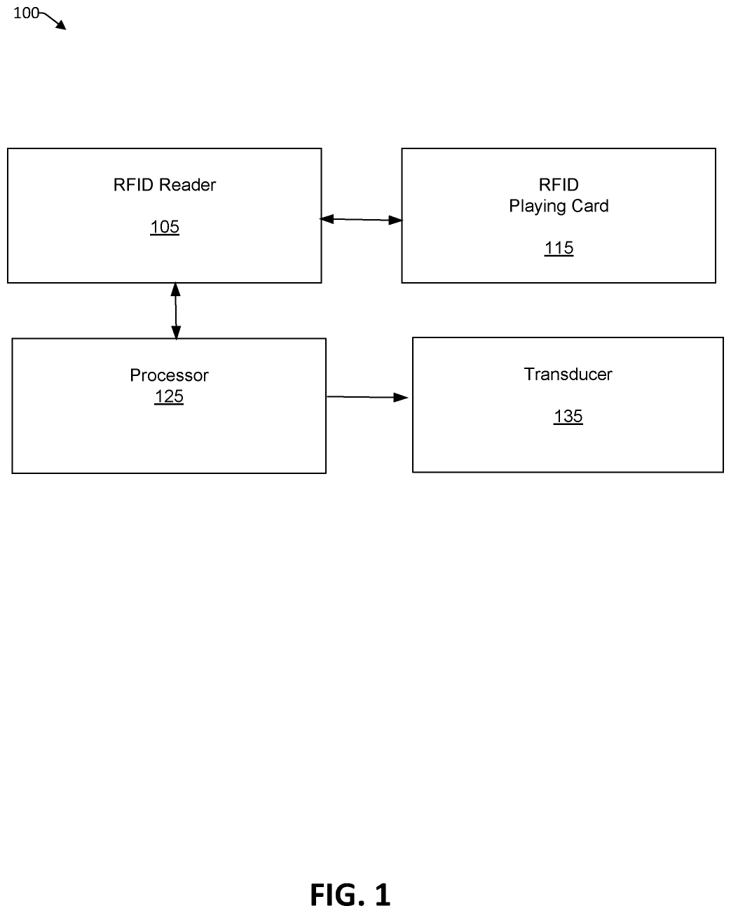

FIG. 1 is a block diagram 100 of an RFID card reading system, consistent with an illustrative embodiment. An RFID reader 105 is configured to the read RFID information. According to this illustrative embodiment, RFID playing cards values 115 have information that is read by the RFID reader 105. While the embodiment, is directed to the game of blackjack, it is to be understood that the RFID reader 105 may be used to read card values for other games, such as a poker.

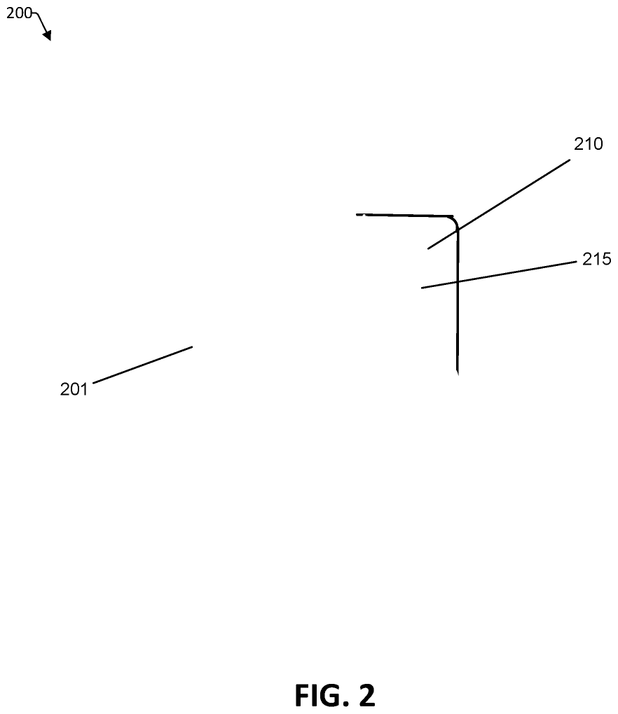

The RFID playing card 115 has an RFID tag. While the tag may be arranged on a surface of the card, in this illustrative embodiment, the RFID tag is provided between the front and the back (see FIG. 2). In a game of blackjack, the RFID reader 105 is arranged to read the dealer's RFID playing cards 115. The RFID reader 105 provides this information to a processor 125. The RFID tag of the playing card 115 may have a numerical value or an alpha numerical value. For example, an Ace may have a value “A”, and the Jack, Queen King and 10 cards may have a value of “B”. A combination of A+B=Stop Play, as the dealer has Blackjack. Alternatively, numerical values may be used, where the Ace may have a value of 11, and the Jack, Queen, King and 10 playing cards have a value of 10. Any combination of the first two cards dealt to the dealer 11+10=21 or A+B=target value Stop Play, as the dealer has Blackjack.

The processor 125 and the RFID 105 reader may be arranged into one device, and communicate through busses. In addition, the processor 125 may separate from the RFID reader 105, and the RFID reader may wirelessly transmit the information to the processor. The RFID reader and the processor may be arranged together in a tablet or smartphone, with the RFID activated by a blackjack app. In addition, the transducer may be a light, a display (separate from the RFID reader and/or processor or part of the same device), an audio device (bell, buzzer, vibrator speaker, etc.). there may be a visual, audiovisual, or audio indication by the transducer 135. There may also be a tactile indication. In the case of a smartphone, tablet, server, etc., the actuator 135 may be a speaker that plays a WAV file or similar. As discussed above, the actuator 135 may display a sound, image, moving images, if the dealer cards are 21 (a predetermined value). In addition, the processor 125 may signal the actuator 135 to indicate when the dealer does not have the predetermined value (e.g., 21) with a message letting the players know this information. The message may be humorous, serious or otherwise provided for entertainment purposes.

FIG. 2 is an illustration 200 of a RFID card, consistent with an illustrative embodiment. The card 201 shown includes an antenna 210 and RFID information configured in the wires 215. The RFID reader 105 reads the information by reflecting a signal off the antenna 215. As discussed above, the RFID reader 105 then communicates with the processor 125 such as shown in FIG. 1

FIG. 3 is an illustration of table 300 including the RFID card reading system, consistent with an illustrative embodiment. The table 300 may be used for different card games, including but not limited to blackjack and poker. The table includes a round surface 310 as shown in FIG. 3, but any desired shape can be used. On the table's 300 surface, or embedded in the table's surface, are one or more RFID/NFC reader(s) 105. A processor/CPU 125 may be arranged in, on, or under the table that communicates with the RFID/NFC reader(s) 315. Alternatively, the processor/CPU 125 may be separate from the table 300) e.g., a server, cellphone, tablet, laptop). A light 319 may be arranged in or under the table 300. Alternatively, a light or a display 325 may be arranged in the table surface, or a display 320 may extend from the table 300 or can be attached to the table. The table may be constructed of an acrylic, or may include an acrylic lens 326 embedded in the table. There may be felt 330 on the surface of the table 311. Materials other than felt 330 (such as wool, cloth, etc.) may be used. The monitor 320 may display a video, or a visual indication of blackjack (or that a predetermined value of cards read by the RFID reader 105) has been reached. The monitor 320 may include at least one speaker, or it may be arranged separately from the monitor. In addition, or alternatively, a light 325 may be arranged on the table surface or embedded in the table so as to be visible when lit from above the table surface. The RFID/NFC reader(s) may be arranged at a dealer station and/or dispersed throughout the table surface. The RFID/NFC readers 105 can be individually activated, so that in the case of poker all the cards may be read. However, in the case of blackjack, just the dealer's cards may be read. It is also understood that in an embodiment, the processor may identify the cards scanned to a player via a headset. This design permits visually-impaired people to play cards more easily, as one could play poker or blackjack and receive an audio indication of their blackjack score, or their poker cards, via a headset.

### Method

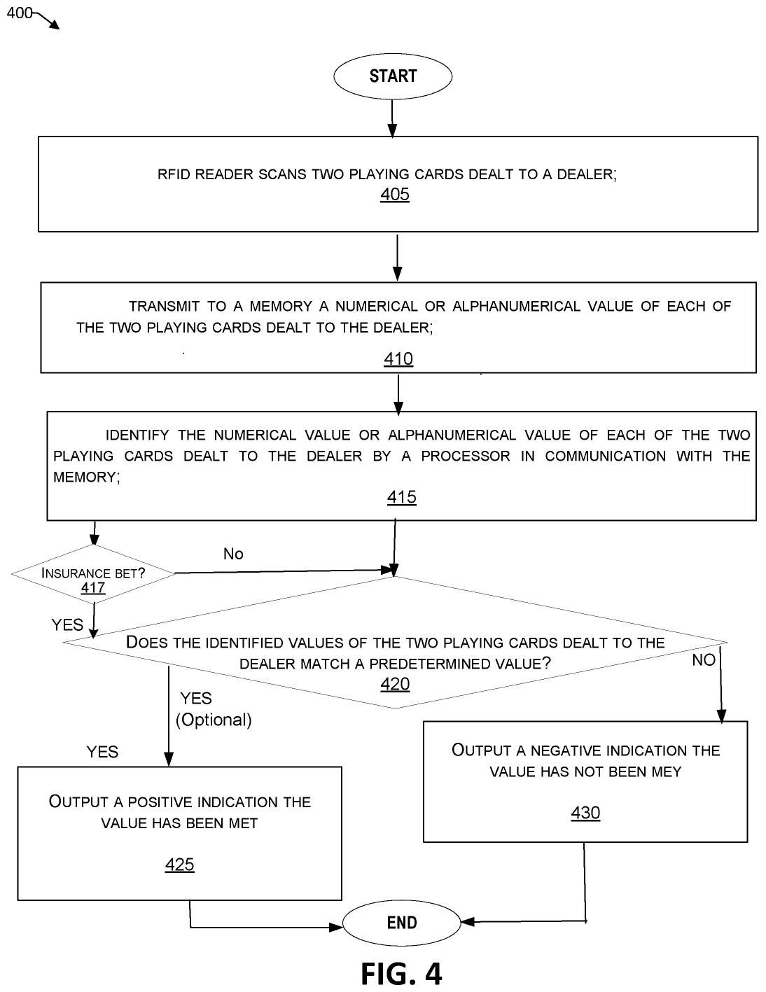

With the foregoing overview of the example architecture, it may be helpful now to consider a discussion of an example method of manufacturing process. To that end, FIG. 4 is a flowchart providing an operational overview of a computer-implemented method of an RFID blackjack, consistent with an illustrative embodiment.

FIG. 4 is shown as a collection of blocks, in a logical order, which represents a sequence of operations that may be performed in a different order than shown and described. In each process, the order in which the operations are described is not intended to be construed as a limitation, and any number of the described blocks can be combined in any order and/or performed in parallel to implement the process.

At operation 405, an RFID reader (see RFID reader 105 in FIG. 1) scans two cards dealt to a dealer. The RFID reader 105 (which may be an NFC reader) reads the cards and adds or identifies their value.

At operation 410, the RFID reader 105 transmits the scanned value of the two scanned cards to a memory for processing. The memory may be a buffer of a processor 125 (FIG. 1)

At operation 415, the processor adds or identifies the values of the two scanned cards. There are several ways this may occur. For example, the RFID reader may indicate that the two cards dealt to the dealer are a Jack and a King, and the processor uses a lookup table (LUT) to obtain a value of 10 for each card and add them to obtain a value of 20. The processor may also have the values of the cards directly accessed from storage or a cached memory. Alternatively, the information from the RFID tag of the cards may include a numerical value or an alphanumerical value of each card, and may also include a suit. As discussed hereinabove, the Ace may have a value of “A”, whereas the 10, Jack, Queen and King may have a value of “B”. The combination of A+B being identified (or B+A) in the first two cards received by the dealer, stops the play as the dealer has Blackjack. Thus, the value may be identified (e.g. A, B) or added.

Prior to indicating blackjack, at operation 417, there is an optional prompt with regard to placing insurance bets about the dealer having blackjack.

At operation 420, there is a decision performed by the processor. If the added value of the two playing cards dealt to the dealer is equal to a predetermined value (e.g. A+B, =C or 21), the dealer has blackjack. At operation 425 there is output a positive indication if the value has been met and the dealer has blackjack. In a non-limiting example, a transducer is activated to indicate blackjack. As indicated above, the transducer to indicate blackjack indication may include lights, buzzers, animations, moving images including but not in any way limited to MPEG or Gif (not limited to these formats). The game (at least for this hand) then ends.

At operation 420, in the event that the processor determines the value of the two dealer cards is not 21 or equal, then at operation 430 there is output a negative indication that the value has not been met and the dealer does not have blackjack. The game may then proceed according to blackjack rules (e.g., players are asked whether they want any additional cards). The card reading system may go on standby for further instructions, or may end. Alternatively, the transducer may be activated to display a video that provides encouragement or humor to the players. For example, a video may display a skeleton saying “you are still alive, unlike me” or some other type of phrase. The RFID reading portion of the game may then end.

It is to be noted that if a poker game were being played instead of blackjack, RFID readers 105 throughout the table could keep track of everyone's cards.

While several illustrative embodiments of the present disclosure have been shown and described, numerous variations and alternative embodiments will occur to those skilled in the art. Such variations and alternative embodiments are contemplated, and can be made without departing from the scope of the disclosure as defined in the appended claims.

For example, the RFID blackjack game may use points for betting. In one embodiment, points may not be purchased and downloaded into a member account. However, a membership may be purchased. All accounts will initially have a predetermined number of points. When the account reaches a “0” balance the account becomes inactive. A new membership must be purchased for the house to continue tracking the player points. Accounts that have no activity for a determined amount of time shall forfeit a calculated number of points monthly based upon house rules and procedures until the account is exhausted completely.

The points have no monetary value-therefore, the house can distribute a predetermined number of points to any player or group of players when a computer-programmed internal timer indicates the table has had all player spots full with member players for a predetermined amount of time. This amount of points becomes bonus points to those players sitting at the table at that time the bonus occurs and is distributed to those players. Lights beneath each player spot may light up and cascade to indicate that bonus has occurred. There may be tracking of points for each of the players. The points may be stored for when a player returns to play the game. In an embodiment, the storing of points may depend on the membership status of each individual player.

In casino games such as blackjack, the player plays against the house. With point tracking, players can engage in competition against each other. These points may be displayed on a media display screen at the table location. Two different style chips need to be used at each table (size, color, design, RFID tags, etc.). One style for the member and one style for the non-member. This prevents nonmember points being placed into a member account for tracking and transferring points at the table to a member from a nonmember.

A nonmember player may request chips from the house up to and according to the predetermined established rules and regulations set by the house providing that there is a vacancy at the blackjack table for a nonmember. If a member is waiting to play, the nonmember player forfeits all his/her chips (points) at the table must surrender his spot to the new member player to join the action. A member player has table priority and may exercise that right at any time between hands upon any nonmember player. The nonmember player then forfeits any chips in his bank to the house and surrenders his seat to the member player.

It is to be understood that the above-description is applicable to all casino games where the players cards or hand is against the house or where the players at the game table are all members.

As used in this specification and the appended claims, the terms “coupled” and “connected to” may have intervening elements arranged between a first element and a second element.

As used in this specification and the appended claims, the singular forms “a,’‘an,” and “the” include plural referents unless the content clearly dictates otherwise. The term plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one”. unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, paragraph (f), unless the element is expressly recited using the phrase “means for. and no method or process step herein is to be construed under those provisions unless the step, or steps, are expressly recited using the phrase “step(s) for . . . .”

What is claimed is:

1. A playing card reading device, comprising:
an antenna;
a Radio Frequency Identification (RFID) reader connected to the antenna, the RFID reader configured to transmit and receive one or more signals to read a value of an RFID tag of one or more playing cards;
a processor connected to the RFID reader, the processor is configured to identify the value of each of the one or more playing cards;
a memory connected to the processor, the memory is configured to store the value of the one or more playing cards identified by the processor; and
a transducer configured to receive a signal from the processor and output one or more of an audio indication, a visual indication, an audio-visual indication, and/or a tactile indication that a predetermined numerical or alphanumerical value of the identified one or more playing cards has occurred.

2. The card reading apparatus according to claim 1, wherein the RFID tag of the one or more playing cards has the predetermined numerical value or an alphanumerical value received by the RFID reader.

3. The card reading device according to claim 1, where the processor is further configured to send the signal to the transducer upon receiving an input regarding an insurance bet status.

4. The card reading device according to claim 1, wherein the value of at least one of the playing cards read by the RFID reader comprises a dealer hole card in which its value is not visible from a back side of the playing card.

5. The card reading device according to claim 4, wherein at least some of the one or more of the playing cards comprises a face card or a 10 card, and
wherein the processor identifies the 10 card or another alphanumeric indicator as the value of the playing card.

6. The card reading device according to claim 5, wherein the predetermined numerical or alphanumeric value of the combined or added one or more playing card corresponds to a predetermined numerical or alphanumerical value assigned in the processor.

7. The card reading device according to claim 6, wherein the processor identifies whether an opportunity for an insurance bet is placed or declined by each player prior to outputting the signal to activate the transducer.

8. The card reading device according to claim 7, wherein a value of the Ace card comprises an 11.

9. The card reading device according to claim 1, wherein the card reading device comprises a blackjack game device, and
the processor is further configured to send an output to activate the transducer in response to the predetermined numerical or alphanumerical value of the identified playing cards is blackjack.

10. The card reading device according to claim 9, wherein the one or more playing cards comprises two playing cards, and the RFID reader is configured to read the RFID tag of each of the two playing cards of a dealer, the two playing cards comprising one playing card facing up, and another playing card comprises a dealer's hole card facing down.

11. The card reading device according to claim 1, wherein each of the one or more playing cards include an RFID tag indicating the predetermined numerical or alphanumerical value.

12. The card reading device according to claim 1, wherein the value of the playing cards read by the RFID reader include at least one of the predetermined numerical or alphanumerical value.

13. A Radio Frequency Identification (RFID) playing card, comprising:
a front side displaying an identifier; and
a back side; and
an RFID tag arranged between the front side and the back side of the playing card,
wherein the RFID tag is configured with the value correlating to the identifier displayed on the front side of the playing card.

14. The RFID playing card according to claim 13, wherein the value configured in the RFID tag is a numerical value or an alphanumerical value, and includes a suit.

15. The RFID playing card according to claim 14, wherein the identifier of the playing card is a royal face, or a 10, and wherein the numerical value or alphanumerical value configured in the RFID tag is 10.

16. The RFID playing card according to claim 13, further comprising more than one numerical or alphanumerical value associated with the identifier.

17. The RFID playing card according to claim 16, wherein the identifier is an ace, and the numerical value comprises an assigned value.

18. A computer-implemented method of Radio Frequency Identification (RFID) blackjack, comprising:
scanning, by an RFID reader, two playing cards dealt to a dealer;
transmitting a numerical value or an alphanumerical value of each of the two playing cards dealt to the dealer to a memory;
identifying the numerical or alphanumerical value of each of the two playing cards dealt to the dealer by a processor in communication with the memory; and
activating a transducer to output one or more of an audio indication, a visual indication, an audio-visual indication, and/or a tactile indication that the numerical or alphanumerical value of the two playing cards dealt to the dealer is equal to a predetermined numerical value or a predetermined alphanumerical value.

19. The computer-implemented method according to claim 18, wherein one of the two playing cards dealt to the dealer that is scanned is a hole-card that faces downward so that its numerical or alphanumerical value is not visible from a back side of the playing card.

20. The computer-implemented method according to claim 19, further comprising entering into a standby until another playing card is dealt to the dealer when the identified numerical or alphanumerical value of the two dealer playing cards does not equal the predetermined numerical value or the predetermined alphanumerical value.

21. The computer-implemented method according to claim 18, wherein the predetermined numerical value is 21, and wherein the value of each of the two playing cards shown on a front side matches a value on an RFID tag arranged between the front side and the back side of each of the two playing cards.

22. The computer-implemented method according to claim 18, further comprising determining whether an insurance bet is placed or declined by each player prior to outputting the signal to activate the transducer to output the one or more of the audio indication, the visual indication, the audio-visual indication, and/or the tactile indication.

23. The computer-implemented method according to claim 18, further comprising tracking points for one or more players according to house rules of blackjack.

24. The computer-implemented method according to claim 23, further comprising storing the tracking points in a storage device for the one or more players based on a membership status.
